(19) United States
(12) Patent Application Publication
(10) Pub. No.: US 2025/0103882 A1
(43) Pub. Date: Mar. 27, 2025

(54) EFFICIENT ADAPTATION OF MACHINE LEARNING MODELS USING RANDOM MATRICES

(71) Applicant: QUALCOMM Technologies, Inc., San Diego, CA (US)

(72) Inventors: Dawid Jan KOPICZKO, Amsterdam (NL); Yuki Markus ASANO, Amsterdam (NL); Tijmen Pieter Frederik BLANKEVOORT, Amsterdam (NL)

(21) Appl. No.: 18/583,291

(22) Filed: Feb. 21, 2024

Related U.S. Application Data
(60) Provisional application No. 63/585,779, filed on Sep. 27, 2023.

(51) Int. Cl. G06N 3/08

(52) U.S. Cl. CPC G06N 3/08

(57) ABSTRACT

Certain aspects of the present disclosure provide techniques and apparatus for efficiently adapting a machine learning model from a base task to a downstream task based on frozen matrices. An example method generally includes receiving an input for processing through a layer of a neural network. An output of the layer of the neural network is generated based on a first product, the first product being based on a first trainable scaling vector, a first frozen matrix, a second trainable scaling vector, a second frozen matrix, and the received input.

### CROSS-REFERENCE TO RELATED APPLICATIONS

This application claims priority to and benefit of U.S. Provisional Patent Application Ser. No. 63/585,779, entitled “Efficient Adaptation of Machine Learning Models Using Random Matrices,” filed Sep. 27, 2023, and assigned to the assignee hereof, the entire contents of which are hereby incorporated by reference.

### INTRODUCTION

Aspects of the present disclosure relate to machine learning models.

Machine learning models can be used to perform various tasks, such as tasks based on computer vision, natural language processing, audio processing, and the like. Single-purpose models may be trained to perform a specific task. For example, in an autonomous driving scenario, different models may be trained to perform semantic segmentation (e.g., to divide visual content into different regions corresponding to different types of objects), object detection, motion prediction, and the like. In another example, generative artificial intelligence models may be trained to generate responses to queries from different data domains. In such a case, one model may be trained to generate responses based on a general knowledge database, and other models may be trained to generate responses based on domain-specific knowledge databases.

Training and maintaining multiple machine learning models to perform related tasks may be computationally expensive. Thus, to reduce the computational expense of maintaining multiple models, various techniques can be used to adapt a model (e.g., a pre-trained large language model) to perform a variety of downstream tasks. For example, in transfer learning, machine learning models pre-trained on large-scale datasets can leverage the knowledge obtained from one dataset to perform a different but related task (e.g., transferring classification-related knowledge for classifying one type of object to classifying a different type of object in image data). To perform transform learning, portions of the machine learning model can be finetuned in order to adjust a pre-trained model for a downstream task different from the original, or source, task for which the model was trained. Finetuning the machine learning model generally produces a separate copy of the pre-trained model parameters for each task. Although generating different versions of the pre-trained model parameters for different tasks may be a useful approach, efficiency may decrease as the number of downstream tasks for which a model is trained increases. Such finetuning may be computationally expensive, leading such models to be impractical or infeasible to deploy on memory-constrained systems (e.g., edge devices, such as mobile phones or other computing devices with limited computational and/or memory capabilities).

### BRIEF SUMMARY

Certain aspects generally relate to efficient adaptation of machine learning models.

Certain aspects provide a processor-implemented method for efficiently adapting a machine learning model from a base task to a downstream task based on frozen matrices. The method generally includes receiving an input for processing through a layer of a neural network. An output of the layer of the neural network is generated based on a first product, the first product being based on a first trainable scaling vector, a first frozen matrix, a second trainable scaling vector, a second frozen matrix, and the received input.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and apparatus comprising means for performing the aforementioned methods as well as those further described herein.

The following description and the related drawings set forth in detail certain illustrative features of one or more aspects.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 depicts an example of adaptation of a machine learning model based on low-rank matrices.

FIG. 2 illustrates an example of adapting a machine learning model based on random frozen matrices and learned scaling vectors, in accordance with aspects of the present disclosure.

FIG. 3 illustrates example operations for inferencing using a machine learning model adapted from a base model to perform a downstream task based on random frozen matrices and learned scaling vectors, in accordance with aspects of the present disclosure.

FIG. 4 illustrates an example system on which aspects of the present disclosure may be executed, in accordance with aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for efficiently adapting machine learning models based on frozen matrices and learned scaling matrices.

Machine learning models may be trained and deployed to perform various tasks, such as computer vision-related tasks, natural language processing, and audio processing and/or analysis, with machine learning models pre-trained on large-scale datasets to leverage the knowledge gained while training a machine learning model to perform an initial task. In some cases, these machine learning models may include various generative models, such as large language models used in generating natural language responses to natural language prompts and other generative models used in generating content in response to a prompt. Generally, these models may be trained to perform a base task, and subsequently, the trained base model may be adapted to perform various downstream tasks. Such adaptation may be performed using various finetuning techniques that update the parameters of the trained base model in order to allow the model to perform a downstream task that is different from, but related to, the base task for which the base model was trained (e.g., finetuning a generative artificial intelligence model trained to generate responses to general knowledge prompts to allow the finetuned model to generate responses to domain-specific prompts). Generally, finetuning the layers produces a separate copy of the pre-trained model parameters for each task, while finetuning the last classification layer may reduce the computational expense of transfer learning at the expense of inference performance on downstream tasks (e.g., tasks other than the original task for which the machine learning model was trained). In some cases, adaptation may be performed using adapter layers inserted into a machine learning model.

Aspects of the present disclosure provide techniques for efficiently adapting a machine learning model to perform a downstream task based on frozen matrices and learned scaling vectors. Generally, these frozen matrices may be fixed random matrices used across different tasks (e.g., a task for which a base model has been originally trained), and weights in the base model may be modified based on the frozen matrices and the learned scaling vectors to adapt the base model to perform a task different from the task for which the base model has been originally trained. As discussed in further detail below, changes to the weights in the base model may be efficiently modeled based on frozen matrices, which may be randomly generated, and associated scaling vectors that are learned based on data associated with the downstream task for which the model is being adapted. By adapting a model based on these frozen matrices and associated learned scaling vectors, aspects of the present disclosure may significantly reduce the number of trainable parameters included in a machine learning model and correspondingly reduce the computing resources (e.g., storage) used to adapt a machine learning model and store the data defining how to adapt the base machine learning model to a downstream task. Further, because the amount of data involved in adapting a model to a downstream task may be significantly reduced, latencies involved in swapping data into and out of on-processor memory may be reduced, which may allow for inferencing operations to be performed using fewer computing resources (e.g., processing cycles, power, etc.) than would be used by finetuned models adapted to the same downstream task.

### Example Adaptation of Machine Learning Models Using Low-Rank Matrices

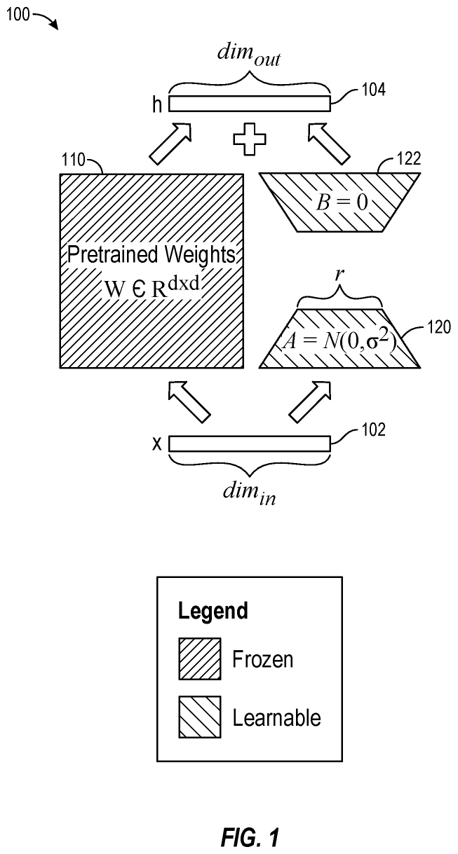

FIG. 1 depicts an example machine learning model 100 adapted from a base machine learning model to perform a downstream task based on low-rank matrices. Generally, low-rank matrices may include matrices in which there are fewer linearly independent columns than the total number of columns in these matrices. Generally, these matrices may allow for efficient representation using rank factorization, which allows for operations using these matrices to be efficiently performed.

The machine learning model 100 generally includes one or more layers, each of which may be associated with a set of parameters (e.g., weights) generated while training the machine learning model to perform a base task. For example, as discussed above, if the machine learning model 100 is a large language model trained to generate answers to general knowledge questions, the downstream task for which the machine learning model 100 is trained may include the generation of domain-specific responses to domain-specific questions. While the machine learning model 100 illustrates a single layer that receives an input x 102 and generates an output h 104, it should be recognized that a machine learning model adapted using low-rank matrices may include any number of layers which may be independently adapted to perform a downstream task.

Generally, as illustrated, the machine learning model 100 includes a set of pretrained W weights 110, represented by the expression W∈ [symbol] ^{d×k}, where d corresponds to a dimension of the input x 102 and k corresponds to a number of keys included in the machine learning model 100 (e.g., where the machine learning model 100 implements a transformer architecture in which an output is modeled based on key data, value data, and query data). To generate an output h 104 for the base task for which the machine learning model 100 is trained, thus, the machine learning model 100 can apply the pretrained weights 110 to the input x 102. For example, the output h 104 may be represented by the equation:

h=Wx

To allow the machine learning model 100 to perform a downstream task that is different from, but related to, the base task for which the machine learning model is trained, a first learnable matrix A 120 and a second learnable matrix B 122 may be trained based on data associated with the downstream task. Meanwhile, the pretrained weights 110 may be frozen (e.g., fixed after training the machine learning model 100) to constrain learning (or updating) to the first learnable matrix A 120 and the second learnable matrix B 122. The constraints on updating the pretrained weights 110 may be performed by representing the updates to the pretrained weights 110 to a low-rank decomposition, such that the weights associated with the downstream task are represented by the pretrained weights 110 and a delta weight ΔW=BA. Thus, the output h 104 for the downstream task for which the machine learning model is adapted may be represented by the equation:

$$h = Wx + Δ Wx = Wx + BAx$$

Generally, the learnable matrices A 120 and B 122 may be low-rank matrices that allow for the weights of the machine learning model 100 to be projected into a smaller subspace. For example, the first learnable matrix A 120 may be represented by the expression A∈ [symbol] ^{r×k}, and the second learnable matrix B 122 may be represented by the expression B∈ [symbol] ^{d×r}, where r represents the rank of these matrices and r<<min(d,k). In some aspects, the learnable matrix A 120 may be initialized as a random matrix (e.g., using Gaussian initialization), and the learnable matrix B 122 may be initialized as a matrix with all zero values, such that ΔW=BA=0 before the machine learning model 100 is adapted to perform a downstream task. During adaptation to generate values in the matrices A 120 and B 122 that adapt the pretrained weights 110 from the weights associated with a base task to weights associated with a downstream task, ΔWx may be scaled by the factor α/r, where α is constant in r. In some aspects, tuning α may adjust the learning rate and may be set to the first value of r used in adapting the machine learning model 100 so that the hyperparameters of the machine learning model 100 need not be retuned as r is adjusted.

Generally, the adaptation of the machine learning model 100 using low-rank matrices allows for the machine learning model 100 to be flexibly deployed to perform a variety of downstream tasks by replacing the learnable matrices A 120 and B 122 for one downstream task with different learnable matrices A 120 and B 122 for another downstream task. Further, because the architecture of the machine learning model 100 remains unchanged, inferencing operations for the base task for which the machine learning model 100 is trained and the downstream tasks for which the machine learning model is adapted may be performed with minimal or no increases in inference time (and corresponding computing resource utilization, such as processor time, memory utilization, power, etc.). However, these learnable matrices A 120 and B 122 may still be large matrices, and the size of these matrices may scale with the complexity of the machine learning model 100. Because these matrices may still use significant amounts of memory, inferencing operations using these matrices may still incur various latency penalties in inferencing as these matrices are swapped into and out of on-processor memory (as a processor may not be able to execute operations involving these matrices until these matrices are swapped into on-processor memory).

### Example Adaptation of Machine Learning Models Using Low-Rank Matrices and Learned Scaling Vectors

To improve the computational efficiency of inferencing and adaptation of a machine learning model from a base task to downstream tasks, aspects of the present disclosure use frozen matrices and learned scaling vectors to represent ΔW for the downstream task, relative to the weights learned for the base task and frozen within a machine learning model. As discussed in further detail herein, aspects of the present disclosure may further reduce the amount of data learned for a downstream task to scaling vectors which may be significantly smaller than the learnable matrices A 120 and B 122 discussed above with respect to FIG. 1. By using these scaling vectors to adapt a machine learning model from a base task to a downstream task, aspects of the present disclosure may further reduce the amount of computational resources used in adapting the machine learning model to a downstream task, which may further improve the speed at which inferences are performed and reduce the amount of processor cycles and time involved in performing a downstream task for which the machine learning model is adapted.

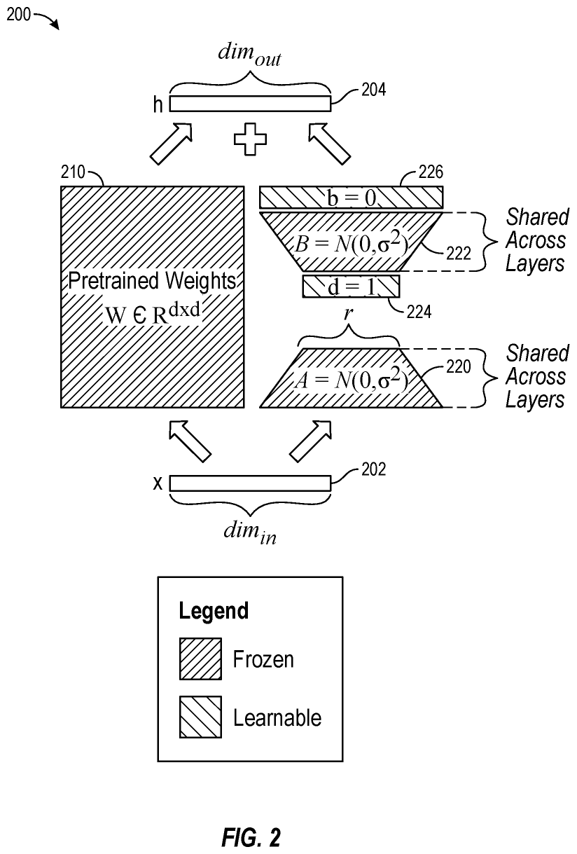

FIG. 2 illustrates an example of a machine learning model 200 adapted based on random frozen matrices and learned scaling vectors, in accordance with aspects of the present disclosure. As with the machine learning model 100 illustrated in FIG. 1, it should be recognized that while the machine learning model 200 illustrates a model including a single layer, the machine learning model 200 may include any number of layers, and one or more layers of the machine learning model may be adapted using the techniques discussed herein.

As illustrated, to generate an output h 204 from an input x 202, the machine learning model 200 can use a set of pretrained weights 210 and can calculate ΔW based on a first frozen matrix A 220, a corresponding first scaling vector 224, a second frozen matrix B 222, and a corresponding second scaling vector 226. The output h 206 may thus be generated according to the equation:

$$h = Wx + Δ Wx = Wx + {Λ}_{b} B {Λ}_{d} Ax$$

where d represents the first scaling vector 224, b represents the second scaling vector 226, and Λ_{d}=diag(d) and Λ_{b}=diag(b) represent conversions of d and b, respectively, into diagonal matrices.

Generally, the first frozen matrix A 220 and the second frozen matrix B 222 may be randomly initialized matrices. To allow for different layers in the machine learning model 200 to be independently adapted from the pretrained weights 210 associated with the base task, the first frozen matrix A 220 and the second frozen matrix B 222 may be shared across layers, and the first scaling vector 224 and the second scaling vector 226 may be learned on a per-layer basis. Generally, the first scaling vector 224 and the second scaling vector 226 may be significantly smaller than the first frozen matrix A 220 and the second frozen matrix B 222, which may allow for adaptation of the machine learning model 200 to perform a downstream task using a small amount of data which may be practical for deployment on computing devices with limited computational resources, such as edge devices (e.g., user equipments in a wireless communication system, such as smartphones, wearable devices, Internet of Things devices, etc.).

Generally, the first scaling vector 224 and the second scaling vector 226 are learned scaling vectors. To learn these scaling vectors, data may be backpropagated from other layers in the machine learning model 200, and a loss may be calculated based on a difference between an output generated by the machine learning model 200 and a ground-truth result associated with an input (e.g., classification, text output for a given text input, etc.).

At inference time, in some aspects, the scaling vectors 224 and 226 may be converted to diagonal matrices Λ_{d}=diag(d) and Λ_{b}=diag(b), respectively. Converting the scaling vectors 224 and 226 to diagonal matrices may allow for matrix multiplication to be performed with respect to the first frozen matrix A 220 and the second frozen matrix B 222, respectively. In some aspects, the learned values of the scaling vector d 224 may enable or disable rows or columns within the first frozen matrix A 220 (e.g., to enable adaptations to weights that should be adapted from the frozen weights in the pretrained weights 210 or disable adaptations to weights that need not be adapted from the pretrained weights 210). The learned values of the scaling vector b 226, meanwhile, may adapt the weights identified for adaptation using the scaling vector d 224.

Generally, the number of trainable parameters |Θ| in the machine learning model 200 may be represented by the equation:

$$\vert Θ \vert = {L}_{tuned} \times ( {d}_{model} + r )$$

where L_{tuned} corresponds to the number of tuned parameters in the machine learning model 200, d_{model} corresponds to a dimensionality of the machine learning model 200 (or a layer thereof), and r corresponds to a rank of the matrices 220 and 222.

The number of trainable parameters in the machine learning model 200 may be significantly lower than the number of trainable parameters in the machine learning model 100, which may be represented by the equation:

$$\vert Θ \vert = 2 \times {L}_{tuned} \times {d}_{model} \times r$$

For example, at a rank of 1, the number of trainable parameters in the machine learning model 200 may be half that as the number of trainable parameters in the machine learning model 200. As the rank increases, the number of trainable parameters may increase by L_{tuned}, which may be a substantially smaller number than the increase in the number of trainable parameters in the machine learning model 100.

In some aspects, because the frozen matrices 220 and 222 may be frozen matrices that can be recreated by a random number generator using a given seed value, the frozen matrices 220 and 222 need not be stored in memory on a computing device on which a machine learning model is deployed. Thus, the amount of memory used to store the values used to calculate ΔW (e.g., the frozen matrices 220 and 222 and the scaling vectors 224 and 226) may equal the sum of the number of bytes used by the scaling vectors 224 and 226 and the number of bytes used to represent the seed used by the random number generator to generate the frozen matrices 220 and 222.

### Example Operations for Efficient Adaptation of a Machine Learning Model Using Low-Rank Matrices and Learned Scaling Vectors

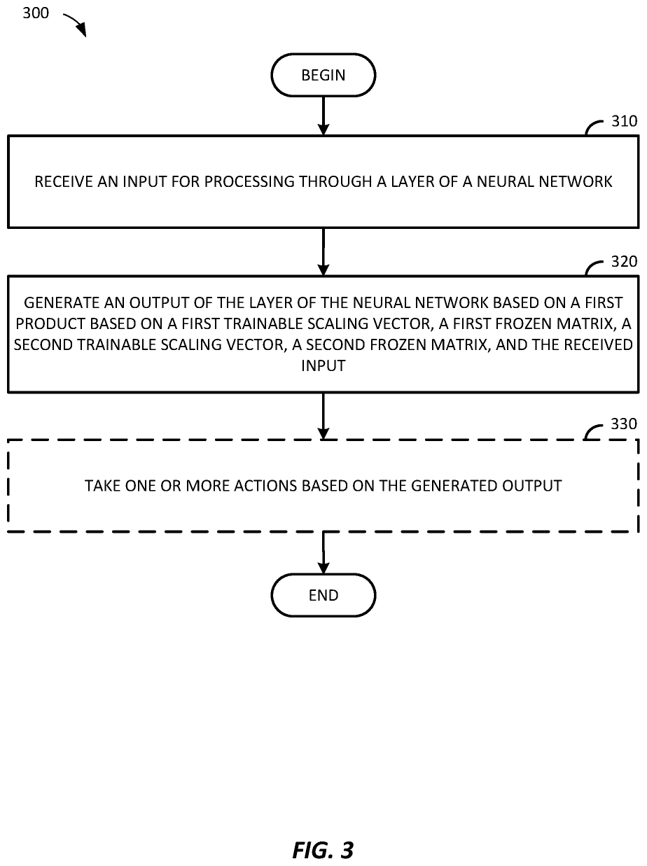

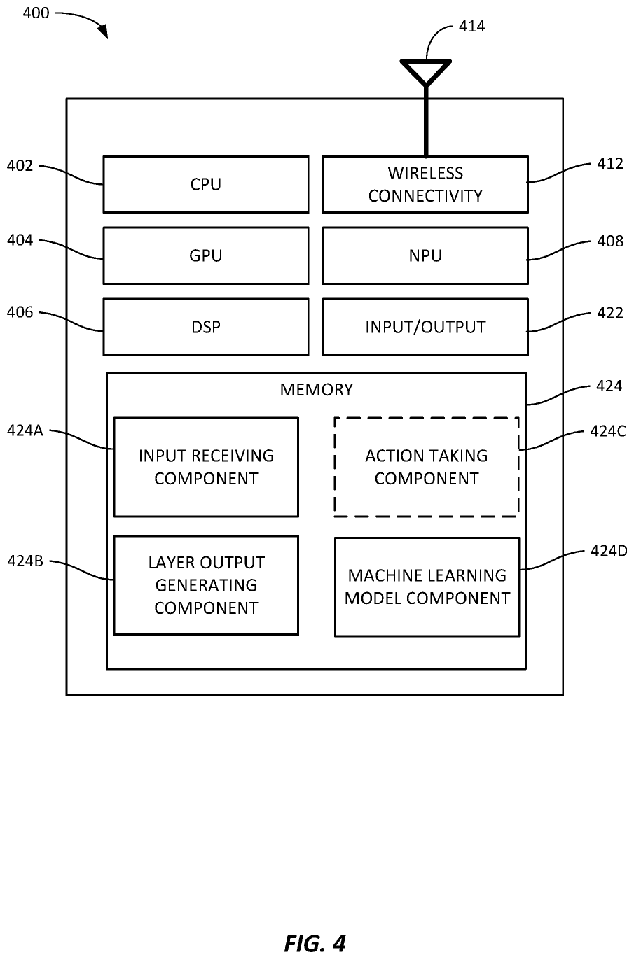

FIG. 3 shows an example of operations 300 for adapting a machine learning model using low-rank matrices and learned scaling vectors, in accordance with aspects of the present disclosure. In some examples, the operations 300 may be performed by a device, such as an example processing system 400 illustrated in FIG. 4.

As illustrated, the operations 300 begin at block 310, with receiving an input for processing through a layer of a neural network.

At block 320, the operations 300 proceed with generating an output of the layer of the neural network based on a first product. The first product may be, for example, the product of a first trainable scaling vector, a first frozen matrix, a second trainable scaling vector, a second frozen matrix, and the received input. For example given a first trainable scaling vector d, a first frozen matrix A, a second trainable scaling vector b, a second frozen matrix B, and an input x, the first product may be represented by the expression Λ_{b}BΛ_{d}Ax.

In some aspects, the first product may represent a learned adaptation weight applied to a corresponding frozen weight in a trained weight matrix (e.g., a weight matrix associated with a base task for which the neural network was trained). Thus, the output may be generated further based on adding, to the first product, a second product based on a trained weight matrix and the received input. The output may thus be represented by the expression Wx+Λ_{b}BΛ_{d}Ax, where W corresponds to the trained weight matrix.

In some aspects, the first frozen matrix and the second frozen matrix may be matrices shared across the layer of the neural network and one or more other layers of the neural network. In such a case, each layer in the neural network may be independently adapted to perform a task different from but related to the base task for which the neural network is trained, such that each layer in the neural network may be associated with that layer's own scaling vectors to apply to the first frozen matrix and the second frozen matrix. The first frozen matrix and the second frozen matrix may be generated, for example, as random matrices using a random number generator and a defined seed value used the random number generator to generate these matrices. Generally, the random number generator may deterministically generate the random matrices for the given defined seed so that the random matrices themselves need not be stored in memory. In such a case, the seed used by the random number generator may be stored and used by the random number generator to recreate the first frozen matrix and the second frozen matrix (e.g., at inference time).

In some aspects, generating the output of the layer of the neural network may include transforming the first trainable scaling vector into a first diagonal matrix and transforming the second trainable scaling vector into a second diagonal matrix. The first product may be calculated by multiplying the first diagonal matrix by the first frozen matrix, by the second diagonal matrix, and by the second frozen matrix, in order.

At block 330, the operations 300 optionally proceed with taking one or more actions based on the generated output of the layer of the neural network.

In some aspects, the one or more actions may include generating an inference based on the generated output of the layer of the neural network. The inference may be, for example, a prediction of a token, or word, corresponding to a most probable next word to be included in a response to a prompt processed by a large language model. In some aspects, the inference may include various predictions or classifications of data in visual content, such as segmentation of an image into different portions corresponding to different types of objects (e.g., foreground and background content, moving and stationary objects, etc.), the identification of objects within an image, motion prediction for objects identified in an image, or the like. It should be recognized that these inference actions are examples of inferences that can be performed based at least in part on the generated output of the layer of the neural network, and other types of inferences (e.g., for different types of data, processed using different neural network architectures) may be contemplated.

In some aspects, the one or more actions may include forward propagating the output of the layer of the neural network to one or more further layers of the neural network. By forward propagating the output of the neural network to one or more further layers of the neural network, generation of a first scaling vector and a second scaling vector for the one or more further layers of the neural network may be triggered.

In some aspects, the operations 300 may further include generating at least one of the first trainable scaling vector or the second trainable scaling vector based on gradient descent and backpropagation of values from one or more other layers of the neural network.

In some aspects, the neural network may be a transformer neural network.

### Example Processing Systems for Efficient Adaptation of a Machine Learning Model Using Low-Rank Matrices and Learned Scaling Vectors

FIG. 4 depicts an example processing system 400 for adapting a machine learning model to perform a downstream task different from a base task and inferencing using the adapted model, such as described herein for example with respect to FIG. 3.

The processing system 400 includes a central processing unit (CPU) 402, which in some examples may be a multi-core CPU. Instructions executed at the CPU 402 may be loaded, for example, from a program memory associated with the CPU 402 or may be loaded from a memory 424.

The processing system 400 also includes additional processing components tailored to specific functions, such as a graphics processing unit (GPU) 404, a digital signal processor (DSP) 406, a neural processing unit (NPU) 408, a multimedia processing unit 410, and a wireless connectivity component 412.

An NPU, such as the NPU 408, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 408, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the plurality of NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 408 is a part of one or more of the CPU 402, the GPU 404, and/or the DSP 406.

In some examples, the wireless connectivity component 412 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and other wireless data transmission standards. The wireless connectivity component 412 is further coupled to one or more antennas 414.

The processing system 400 may also include one or more input and/or output devices 422, such as screens, touch-sensitive surfaces (including touch-sensitive displays), physical buttons, speakers, microphones, and the like.

In some examples, one or more of the processors of the processing system 400 may be based on an ARM or RISC-V instruction set.

The processing system 400 also includes the memory 424, which is representative of one or more static and/or dynamic memories, such as a dynamic random access memory, a flash-based static memory, and the like. In this example, the memory 424 includes computer-executable components, which may be executed by one or more of the aforementioned processors of the processing system 400.

In particular, in this example, the memory 424 includes an input receiving component 424A, an output generating component 424B, an (optional) action taking component 424C, and a machine learning model component 424D. The depicted components, and others not depicted, may be configured to perform various aspects of the methods described herein.

Generally, the processing system 400 and/or components thereof may be configured to perform the methods described herein.

Notably, in other aspects, elements of the processing system 400 may be omitted, such as where the processing system 400 is a server computer or the like. Further, elements of the processing system 400 may be distributed, such as training a model and using the model to generate inferences, such as user verification predictions.

### Example Clauses

Implementation details of various aspects of the present disclosure are described in the following numbered clauses.

Clause 1: A processor-implemented method, comprising: receiving an input for processing through a layer of a neural network; and generating an output of the layer of the neural network based on a first product, the first product being based on a first trainable scaling vector, a first frozen matrix, a second trainable scaling vector, a second frozen matrix, and the received input.

Clause 2: The method of Clause 1, wherein the output is generated further based on adding, to the first product, a second product based on a trained weight matrix and the received input.

Clause 3: The method of Clause 1 or Clause 2, wherein the first product corresponds to a low-rank decomposition of an accumulated weight update during adaptation of the neural network.

Clause 4: The method of any of Clauses 1 through 3, wherein the first frozen matrix and the second frozen matrix comprise matrices shared across the layer of the neural network and one or more other layers of the neural network.

Clause 5: The method of any of Clauses 1 through 4, wherein the first frozen matrix and the second frozen matrix comprise random matrices.

Clause 6: The method of any of Clauses 1 through 5, wherein generating the output of the layer of the neural network comprises: transforming the first trainable scaling vector into a first diagonal matrix; transforming the second trainable scaling vector into a second diagonal matrix; and calculating the first product by multiplying the first diagonal matrix by the first frozen matrix, by the second diagonal matrix, and by the second frozen matrix in order.

Clause 7: The method of any of Clauses 1 through 6, further comprising generating at least one of the first trainable scaling vector or the second trainable scaling vector based on gradient descent and backpropagation of values from one or more other layers of the neural network.

Clause 8: The method of any of Clauses 1 through 7, wherein the neural network comprises a transformer neural network.

Clause 9: The method of any of Clauses 1 through 8, further comprising taking one or more actions based on the generated output of the layer of the neural network.

Clause 10: The method of Clause 9, wherein the one or more actions comprises generating an inference based on the generated output of the layer of the neural network.

Clause 11: The method of Clause 9 or Clause 10, wherein the one or more actions comprises: forward propagating the output of the layer of the neural network to one or more further layers of the neural network; and triggering generation of a first scaling vector and a second scaling vector for the one or more further layers of the neural network.

Clause 12: A processing system comprising: a memory comprising computer-executable instructions; and one or more processors configured to execute the computer-executable instructions and cause the processing system to perform a method in accordance with any of Clauses 1 through 11.

Clause 13: A processing system comprising means for performing a method in accordance with any of Clauses 1 through 11.

Clause 14: A non-transitory computer-readable medium comprising computer-executable instructions that, when executed by one or more processors of a processing system, cause the processing system to perform a method in accordance with any of Clauses 1 through 11.

Clause 14: A computer program product embodied on a computer-readable storage medium comprising code for performing a method in accordance with any of Clauses 1 through 11.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
at least one memory having executable instructions stored thereon; and
one or more processors configured to execute the executable instructions to cause the processing system to:
receive an input for processing through a layer of a neural network; and
generate an output of the layer of the neural network based on a first product, the first product being based on a first trainable scaling vector, a first frozen matrix, a second trainable scaling vector, a second frozen matrix, and the received input.

2. The processing system of claim 1, wherein the one or more processors are configured to cause the processing system to generate the output further based on addition, to the first product, of a second product based on a trained weight matrix and the received input.

3. The processing system of claim 1, wherein the first product corresponds to a low-rank decomposition of an accumulated weight update during adaptation of the neural network.

4. The processing system of claim 1, wherein the first frozen matrix and the second frozen matrix comprise matrices shared across the layer of the neural network and one or more other layers of the neural network.

5. The processing system of claim 1, wherein the first frozen matrix and the second frozen matrix comprise random matrices.

6. The processing system of claim 1, wherein to generate the output of the layer of the neural network, the one or more processors are configured to cause the processing system to:
transform the first trainable scaling vector into a first diagonal matrix;
transform the second trainable scaling vector into a second diagonal matrix; and
calculate the first product by multiplying the first diagonal matrix the first frozen matrix, by the second diagonal matrix, and by the second frozen matrix in order.

7. The processing system of claim 1, wherein the one or more processors are further configured to cause the processing system to generate at least one of the first trainable scaling vector or the second trainable scaling vector based on gradient descent and backpropagation of values from one or more other layers of the neural network.

8. The processing system of claim 1, wherein the neural network comprises a transformer neural network.

9. The processing system of claim 1, wherein the one or more processors are further configured to cause the processing system to take one or more actions based on the generated output of the layer of the neural network.

10. The processing system of claim 9, wherein to take the one or more actions, the one or more processors are configured to cause the processing system to generate an inference based on the generated output of the layer of the neural network.

11. The processing system of claim 9, wherein to take the one or more actions, the one or more processors are configured to cause the processing system to:
forward propagate the output of the layer of the neural network to one or more further layers of the neural network; and
trigger generation of a first scaling vector and a second scaling vector for the one or more further layers of the neural network.

12. A processor-implemented method, comprising:
receiving an input for processing through a layer of a neural network; and
generating an output of the layer of the neural network based on a first product, the first product being based on a first trainable scaling vector, a first frozen matrix, a second trainable scaling vector, a second frozen matrix, and the received input.

13. The method of claim 12, wherein the output is generated further based on adding, to the first product, a second product based on a trained weight matrix and the received input.

14. The method of claim 12, wherein the first frozen matrix and the second frozen matrix comprise matrices shared across the layer of the neural network and one or more other layers of the neural network.

15. The method of claim 12, wherein the first frozen matrix and the second frozen matrix comprise random matrices.

16. The method of claim 12, wherein generating the output of the layer of the neural network comprises:
transforming the first trainable scaling vector into a first diagonal matrix;
transforming the second trainable scaling vector into a second diagonal matrix; and
calculating the first product by multiplying the first diagonal matrix the first frozen matrix, by the second diagonal matrix, and by the second frozen matrix in order.

17. The method of claim 12, further comprising generating at least one of the first trainable scaling vector or the second trainable scaling vector based on gradient descent and backpropagation of values from one or more other layers of the neural network.

18. The method of claim 12, further comprising generating an inference based on the generated output of the layer of the neural network.

19. The method of claim 12, further comprising:
forward propagating the output of the layer of the neural network to one or more further layers of the neural network; and
triggering generation of a first scaling vector and a second scaling vector for the one or more further layers of the neural network.

20. A processing system, comprising:
means for receiving an input for processing through a layer of a neural network; and
means for generating an output of the layer of the neural network based on a first product, the first product being based on a first trainable scaling vector, a first frozen matrix, a second trainable scaling vector, a second frozen matrix, and the received input.
